(19) United States
(12) Patent Application Publication
(10) Pub. No.: US 2006/0179072 A1
(43) Pub. Date: Aug. 10, 2006

(54) Method and system for obtaining a profile

(75) Inventors: David A. Eves, CRAWLEY (GB); Karl J. Wood, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/546,958

(22) PCT Filed: Feb. 11, 2004
(86) PCT No.: PCT/IB04/00435

§ 371 Date: Aug. 25, 2005

(30) Foreign Application Priority Data
Feb. 28, 2003 (GB) 0304612.56

(51) Int. Cl. G06F 17/00; G06F 7/00

(52) U.S. Cl. 707/102

(57) ABSTRACT

This invention relates to a method, and to a system, for obtaining a profile.

This invention relates to a method, and to a system, for obtaining a profile.

In order for advertisers and service providers to target their products and services more efficiently, it is greatly to their advantage to have access to individual information on specific consumers. This information is commonly referred to as a “profile” and user profiling is often carried out by asking users to fill in forms or questionnaires. Basic information about lifestyle choices, age, sex etc is used to try and categorise the consumer and then target advertising or promotions. Most mechanisms for gaining knowledge about the user are intrusive, requiring explicit answers about personal information. Often the consumer will supply incorrect information or withhold it completely until there is a clear value in supplying it.

Most big companies and many agencies have used so-called segmentation studies to attempt to acquire profile information. Usually in order to decide which “market segment” a person belongs to a lot of personal details need to be gathered and various questions asked about their likes and dislikes. This is intrusive and unpopular and also inefficient. Many users also lie and create alternative “personalities” unless they can see an obvious benefit in participating fully in the survey. Many attempts have been to simplify the process e.g. profile passports and comparative systems that assume for example that if you buy a book you might like ones that other people who bought that same book also recommend.

United States of America patent application publication US 2001/0021994 disclose a television system which enables advertisements to be targeted at viewers who have a particular interest in the products or services being promoted by the advertisement. The system comprises reviews from a plurality of reviewers commissioned by the advertiser and alternatively or additionally by independent reviewers. These reviews are encoded into a data channel associated with the advertisement. A product rating decoder is provided in a receiver which decodes the data in the data channel and selects advertisements for display based on the data and a user profile generated either explicitly by the user entering preferences via a user interface or implicitly by monitoring the type of programme selected for viewing by the user.

International patent application publication WO 00/31671 discloses a system for the collection and analysis of user profile information. The system disclosed facilitates a web-based user network interface being created by obtaining user profile information from a database of user profile information. Then, the system gathers behavioural information from the user profile information and statistically analyses the behavioural information to generate graphs indicative of the user's interaction with applications that are presented on a display utilizing agent software. Agent software is also utilized to gather user profile information pertaining to application usage and agent utilization to determine characteristics of a user for use in tuning a consistent user interface to applications.

International patent application publication WO 01/22261 discloses a method and apparatus for creating, archiving, searching and delivering targeted content within a specified Web page. This is aimed at satisfying the critical need for businesses to deliver and for computer users to receive targeted advertisements based on a user's previous online interaction. As computer users surf the Web, their interactions with various queries and polls appearing on specified Web pages give information about their preferences and dislikes. In a preferred embodiment of the invention, various interactive queries or polls are used to encourage user participation in these surveys. The advertising and poll delivery system keeps track of each user's participation in the surveys, and based on the answers a user provides, the system builds a psychographic profile for that particular user. Utilizing a graphical user interface, marketers, advertising agencies, and other entities then use this data to create a marketing campaign that will appeal to specific segments of the online demographic population. The advertising and poll delivery system thus allows marketers to integrate the results of interactive polls into directed advertising and to select when and where such advertising should be delivered.

International patent application publication WO 01/73595 discloses a data search user interface with ergonomic mechanism for user profile definition and manipulation. A user interface for querying and displaying records from a database employs a physical metaphor for the process of constructing queries and viewing results. Queries are defined by selecting predefined criteria rather than entering them as search terms, the former being more compatible with lean-back applications such as searching of electronic program guides. According to the invention, user profiles are presented and manipulated to operate with queries in the same way as other criteria. For example, in one embodiment, the search criteria are shown as the beads on respective strings, the strings representing categories of criteria. One of the strings is a set of user profiles that can be added to a query in the same manner as the addition of criteria. Criteria are selected to form a query by moving corresponding beads to a query string. User preference profiles can be constructed in the same manner. Profiles are saved and represented as bead strings that can be used in further interactions in the same manner as criteria beads. Profiles can also be the result of automatic machine-analysis of user interaction. Thus, the historical usage pattern of a user is used by a machine-learning device to predict user preferences. Such “implicit” profiles can also be added to a query in the same manner as the more typical preference profiles in which users incorporate their explicit preferences in the form of rules into a user profile.

All of these systems acquire profile information by either monitoring the user's responses to specific questions or by monitoring the user's actions over a period of time, for example the television programmes that a user chooses to watch. Both of these known methods have specific weaknesses, the first relying on the user participating honestly in a defined survey and the second gathering only a limited amount of information over too long a period of time.

It is an object of the invention to improve upon the known art.

According to a first aspect of the present invention, there is provided a method for obtaining a profile comprising presenting a user with a series of options for the construction of a user interface, receiving user selections of said options, monitoring said user selections of said options, and constructing a user profile according to said user selections.

According to a second aspect of the present invention, there is provided a system for obtaining a profile comprising a display device for presenting a user with a series of options for the construction of a user interface, a user input device for receiving user selections of said options, and a processor monitoring said user selections of said options and constructing a user profile according to said user selections.

Advantageously, the constructing of the user profile comprises acquiring profile entries from a store, with each of the options for the construction of the user interface having an associated profile entry. Some of the options for the construction of the user interface can have a plurality of associated profile entries, as desired.

In one embodiment, the acquisition of a profile entry is determined by a plurality of user selections of the options for the construction of the user interface. This can be achieved by the user selection of an option for the construction of the user interface creating a score against a profile entry, and the profile entry is acquired for the user profile when its score exceeds a predefined threshold. Preferably, the user selection of an option for the construction of the user interface creates a score against a plurality of profile entries.

Advantageously, the series of options presented to the user is adapted according to the user selection of the options. The method can further comprise further monitoring the user's interactions with the user interface, and modifying the user profile according to the interactions.

Preferably, the system further comprises a storage device for storing profile entries for use in constructing the user profile. Advantageously, the processor is arranged to adapt the series of options presented to the user according to the user selection of the options, and is also arranged to further monitor the user's interactions with the user interface, and modify the user profile according to the interactions. In a preferred embodiment, the display device is part of a digital television receiver and the user input device is a television remote control.

Increasingly electronic user interfaces are designed to allow consumers to personalise their access to content. A good example is the use of “skins” for computer based MP3 players. At present the choice of skin has no effect on the content delivered to the player. A similar example is the downloading of ring tones and graphics for mobile phones, where choices could give clues as to age, gender and personal interests. For example, 30 something males would generally download particular Sci-Fi or action movie TV themes.

By providing a user definable interface that can be constructed from a range of specially designed parts the choices made of elements and styling can be used to create a stereotype personality profile for the user. This can then be used in turn to tailor supplied content e.g. adverts and offers including further options and features that, if chosen, will allow further refinement of the profile. This provides a higher value experience both for the consumer and the content providers. This allows the aggregation of data about user types without the need for intrusive questioning and with greater reliability because the user is unlikely to lie or adopt alternative personas. This data then has marketing and brand value, both directly for the application and in related markets.

Through the use of these deliberately designed user interface elements, each with a specific target audience in mind and stylistic bias, that are offered to the consumer in order to construct a user interface, the user's choices are then used to construct a probability that they fit into certain cultural stereotypes and interest groups. Some such as specific sports team identifiers or brand names can be quite explicit but equally well these could be subtler.

New user interface elements do not have to be specifically designed for the process, as it is possible to reverse engineer the process using existing interfaces. By running sets of user tests on existing users it should be possible to build up patterns between interface choices and user profiles that can then be applied to the user base as a whole. This provides a non-intrusive mechanism for targeting content and gathering profiling data.

Embodiments of the invention will now be described, by way of example only, with reference to the accompanying drawings, in which:—

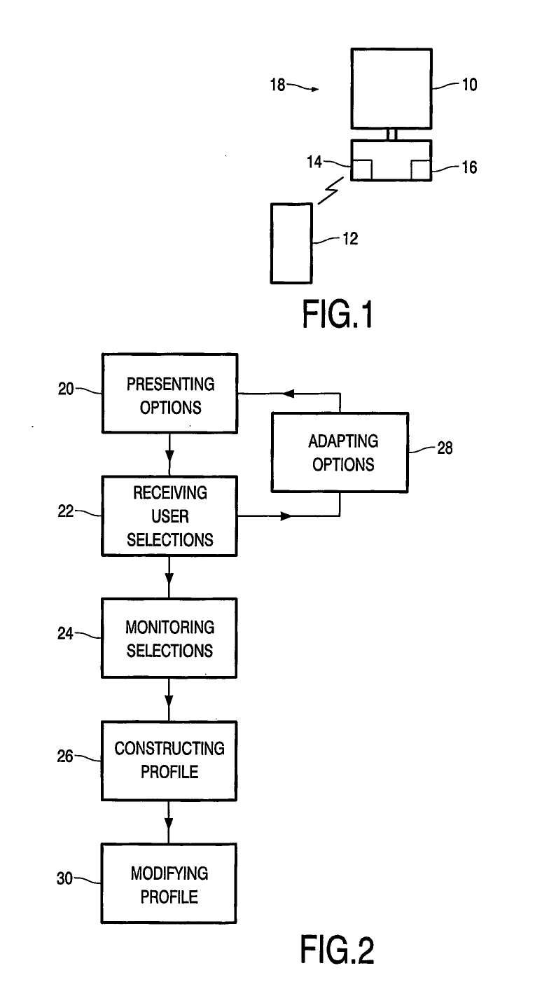

FIG. 1 is a schematic diagram of a system for obtaining a profile,

FIG. 2 is a flow diagram of a method for obtaining a profile,

FIG. 3 is a schematic diagram illustrating a relationship between options for construction of a user interface, profile entries and a user profile, and

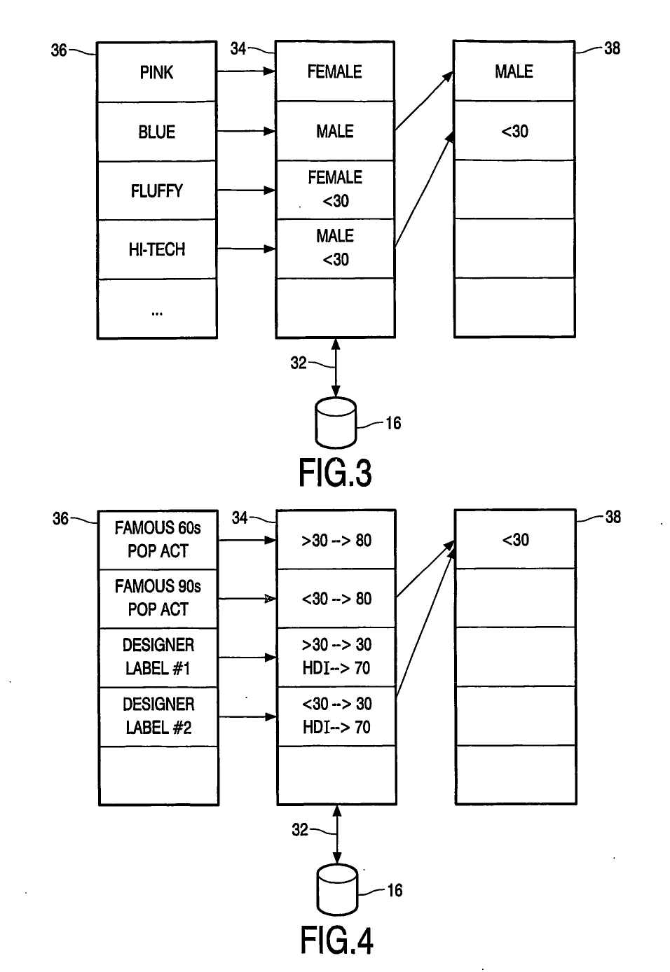

FIG. 4 is a schematic diagram illustrating an alternative relationship between options for construction of a user interface, profile entries and a user profile.

The system shown in FIG. 1 is a system for obtaining a profile and comprises a display device 10 for presenting a user with a series of options for the construction of a user interface, a user input device 12 for receiving user selections of the options, and a processor 14 for monitoring the user selections of the options and constructing a user profile according to those user selections. The display device 10 is part of a digital television receiver 18 and the user input device 12 is a television remote control 12. The receiver 18 and the remote control 12 communicate via a short-range radio or infrared link, as is well known in the art. The system further comprises a storage device 16 for storing profile entries for use in constructing the user profile.

The operation of the system will now be described in more detail, with reference to the method of FIG. 2. The basic steps of the method for obtaining a profile comprise presenting 20 a user with a series of options for the construction of a user interface, receiving 22 user selections of the options, monitoring 24 the user selections of the options, and constructing 26 a user profile according to the user selections.

The presenting 20 is presenting to a user a downloadable on-screen interface for the digital receiver 18, commonly referred to as a set top box. Any company that offers a set top box based service will offer various added value features such as simple games, online betting, web access etc. In order to access these services an on screen menu application is used that is controlled using the remote control 12. State of the art set top boxes allow for a rich set of graphics to be used in this interface and we are proposing a system where a “skin” can be created for this interface from a user selection of one or more of a series of options, for example, a background image, buttons, scrollbars and extra cosmetic “add-ons”. The user can choose from the selection of each of the offered options to make up their own interface look and feel as desired, and the choices made by the user do not change the underlying functionality of the interface itself.

The offered selection of add-ons is deliberately designed to appeal to specific market segments and user types. For example, there are a range of graphics that: reflect certain soccer team loyalties, or have a heavy use of ‘Barbie pink’, feature chrome effects, use a sci-fi styling and so on. These are designed so that they can either be used to create a consistent single look or be mixed and matched.

A set of algorithms can be used to match known user profiles (based on marketing data) to the combinations of user interface elements that have been selected. One way to set up such a matching algorithm would be to conduct a range of user tests with people of a known profile and use statistical matches between those known selections and those of the target end users. Such matches will provide indicators both of particular social groupings i.e. gender, age, hometown, but also more individual tastes, interests and buying habits.

Finding strong “interface stereotypes” is probably best done through statistical analysis of the content itself. Effectively, prior tests are run on a known and trusted set of users and profiles, with the results being used to determine the appropriate aspect of the profile that matches the option in the user interface. For example, a range of add-ons could be created and tested with those providing the clearest results being selected for use in the final offering. Simple examples of these would be:

Crystal Palace away strip background

Probability of user being male and under 45

Probably resident/brought up in southeast or has affinity to area.

Sporting interest

Barbie Pink Scrollbar

Probably Female or Gay

Under 25

Single

Not interested in Sport

By combining such indication from a range of user interface elements the profile becomes stronger and richer. At very least it should provide a starting point from which other approaches (e.g. monitoring buying patterns or targeted questions) could be used to refine the information.

In order to construct the profile, the step 26 of constructing the user profile comprises acquiring profile entries from the store 16. This is illustrated in FIG. 3, which is a schematic diagram showing a first example of the relationship between options 36 for construction of a user interface, profile entries 34 and the user profile 38. The arrow 32 illustrates the acquiring of the entries 34 from the store 16.

The profile entries 34 are entered in the profile 38 of the user as the user makes their selection of the various options 36 available to them. In the simplest embodiment, each of the options for the construction of the user interface has an associated profile entry. As shown in the Figure, the option “pink” corresponds to the profile entry “female”. When the user selects a particular option, in this example “blue”, then the associated profile entry, “male”, is copied into the profile 38. In more complicated arrangements, at least one of the options for the construction of the user interface has a plurality of associated profile entries. When the user selects this option then the plurality of associated profile entries are copied into the profile. In this example, the option “hi-tech” is associated with the entries “male” and “<30”.

The acquisition of a profile entry can be determined by a plurality of user selections of the options for the construction of the user interface. For example a particular profile entry may only copied into the profile if the user selects two different options. This is shown in FIG. 4, which is a schematic diagram illustrating an alternative relationship between the options 36 for construction of a user interface, profile entries 34 and the user profile 38. In this example, the user selection of an option for the construction of the user interface creates a score against a profile entry, and the profile entry is acquired for the user profile when its score exceeds a predefined threshold. In this example, the threshold is 100 and selection of the “famous 90s pop act” as a feature in the user interface gives a score of 80 to the associated entry “<30”. The user selection of an option for the construction of the user interface can also create a score against a plurality of profile entries. So the selection of “designer label #2” creates a score of 30 against “<30” and a score of 70 against “hdi (high disposable income)”. In this example the selection of “famous 90s pop act” and “designer label #2” by the user creates a combined score of 110 against “<30”, which is greater than the threshold of 100, and this is therefore entered in the profile 38.

Two enhancements to the basic methodology are possible. Firstly, the series of options presented to the user is adapted according to the user selection of the options. This step is illustrated at step 28 of FIG. 2. Effectively this creates a feedback loop that allows certain options to be offered to the user dependant on their earlier choices. For example if it becomes clear that they like sport then specific options will be offered to find out which sports in particular they are interested in. Secondly, it is possible to further monitor the user's interactions with the user interface, and modify the user profile according to the interactions. This step is illustrated at step 30 of FIG. 2. In this way a more accurate profile is developed over time, with further actions by the user being interpreted to gain information about their desires and preferences. For example, if the original profile contains the entry “sport”, and the user then accesses via the user interface, for example, darts programmes regularly over a period of time then the profile can be updated to include the entry “darts”.

1. A method for obtaining a profile comprising presenting (20) a user with a series of options (36) for the construction of a user interface, receiving (22) user selections of said options (36), monitoring (24) said user selections of said options (36), and constructing a user profile (38) according to said user selections.

2. A method according to claim 1, wherein said constructing a user profile (38) comprises acquiring (32) profile entries (34) from a store (16).

3. A method according to claim 2, wherein each of said options (36) for the construction of the user interface has an associated profile entry (34).

4. A method according to claim 3, wherein at least one of said options (36) for the construction of the user interface has a plurality of associated profile entries (34).

5. A method according to claim 2, wherein the acquisition of a profile entry (34) is determined by a plurality of user selections of said options (36) for the construction of the user interface.

6. A method according to claim 5, wherein the user selection of an option (36) for the construction of the user interface creates a score against a profile entry (34), and said profile entry (34) is acquired for said user profile (38) when its score exceeds a predefined threshold.

7. A method according to claim 6, wherein the user selection of an option (36) for the construction of the user interface creates a score against a plurality of profile entries (34).

8. A method according to claim 1, wherein said series of options (36) presented to said user is adapted (28) according to the user selection of said options (36).

9. A method according to claim 1, and further comprising further monitoring (30) said user's interactions with said user interface, and modifying said user profile (38) according to said interactions.

10. A system for obtaining a profile comprising a display device (10) for presenting a user with a series of options (36) for the construction of a user interface, a user input device (12) for receiving user selections of said options (36), and a processor (14) monitoring said user selections of said options (36) and constructing a user profile (38) according to said user selections.

11. A system according to claim 10, and further comprising a storage device (16) for storing profile entries (34) for use in constructing said user profile (38).

12. A system according to claim 10, wherein said processor (14) is arranged to adapt said series of options (36) presented to said user according to the user selection of said options (36).

13. A system according to claim 10, wherein said processor (14) is arranged to further monitor said user's interactions with said user interface, and modify said user profile (38) according to said interactions.

14. A system according to claim 10, wherein said display device (10) is part of a digital television receiver (18) and said user input device (12) is a television remote control (12).
